(19) United States
(12) Patent Application Publication
(10) Pub. No.: US 2006/0244800 A1
(43) Pub. Date: Nov. 2, 2006

(54) Block copolymer, polymer-containing composition including the block copolymer, and ink composition

(75) Inventors: Ikuo Nakazawa, Tokyo (JP); Koichi Sato, Tokyo (JP); Sakae Suda, Tokyo (JP); Ryuji Higashi, Tokyo (JP); Masayuki Ikegami, Tokyo (JP); Keiichiro Tsubaki, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/545,618

(22) PCT Filed: Oct. 29, 2004
(86) PCT No.: PCT/JP04/16474

§ 371 Date: Aug. 16, 2005

(30) Foreign Application Priority Data
Nov. 5, 2003 (JP) 2003-375387 (PAT)

(51) Int. Cl. G01D 11/00

(52) U.S. Cl. 347/100

(57) ABSTRACT

A block copolymer including two or more segments, wherein at least one of the segments is a gradient copolymer including two or more monomer components.

### TECHNICAL FIELD

The present invention relates to a novel block copolymer, a polymer-containing composition including the block copolymer and a functional substance, an ink-jet ink composition, and an ink-applying method and an ink-applying apparatus which use the ink-jet composition.

### BACKGROUND ART

Compositions including particulate solid materials have hitherto been known as functional materials in the forms of agricultural chemicals such as herbicides and insecticides; medical drugs such as anticancer drugs, antiallergic drugs and antiphlogistic drugs; and toners and inks using the functional materials as coloring materials. In these years, digital printing techniques have been progressing very vigorously. Typical examples of the digital printing techniques include the electrophotography technique and the ink-jet technique; the significance of presence of the digital printing techniques has been increasingly raised as the image forming technique being used and to be used at offices, homes and the like.

Among the digital printing techniques, the ink-jet technique is characterized as a direct recording method by the fact that the ink-jet technique provides compactness and low electric power consumption. Additionally, micro-fabrication of nozzles and the like are rapidly promoting development of high-quality images. An example of the ink-jet technique is a method of heating an ink supplied from an ink tank by a heater inside a nozzle to vaporize and bubble the ink, whereby the ink is ejected to form an image on a recording medium. Another example of the ink-jet technique is a method of ejecting an ink by causing a piezoelectric element to vibrate. Development of these techniques are amazingly improving image quality of digital color printing to have already reached a level comparable to that of silver salt photography. Digital color printing is required to have weather resistance when digital color printing is to be alternative to silver salt photography and printing. For the purpose of improving these factors, use of a pigment-dispersing ink (for example, see U.S. Pat. No. 5,085,698, pages 2 to 3) and laminate processing have been investigated. However, the present situation is such that much improvement is still demanded.

### DISCLOSURE OF THE INVENTION

The present invention has been achieved in view of the above-described background, and provides a block copolymer including a segment which is a gradient copolymer composed of at least two or more monomer components, and capable of satisfactorily dispersing a functional substance in a solvent.

Also, the present invention provides a polymer-containing composition which includes the above-described block copolymer and has a satisfactory dispersibility of a functional substance.

Further, the present invention provides an ink composition which contains the above-described block copolymer, has a satisfactory dispersibility of a coloring material and has a satisfactory fixability of the coloring material.

Additionally, the present invention provides an ink-applying method and an ink-applying apparatus for stably ejecting the composition having a satisfactory dispersibility.

The present inventors have diligently investigated the above-described background art and problems of the prior art, and consequently have accomplished the present invention.

The present invention relates to a block copolymer including two or more segments, wherein at least one of the segments is a gradient copolymer composed of two or more monomer components.

Also, the present invention relates to a polymer-containing composition including the block copolymer, a solvent or a dispersion medium, and a functional material.

Additionally, the present invention relates to an ink composition including the block copolymer, a solvent or a dispersion medium, and a coloring material.

Further, the present invention relates to an ink-applying method including a step of applying the ink composition to a medium.

Furthermore, the present invention relates to an ink-applying apparatus including an ink-applying means for energizing the ink composition to apply the ink composition onto a medium, and a drive means for driving the ink-applying means.

According to the present invention, there can be provided a block copolymer including a segment which is a gradient copolymer composed of at least two or more monomer components, and capable of satisfactorily dispersing a functional substance in a solvent.

Also, the present invention can provide a polymer-containing composition which includes the block copolymer and has a satisfactory dispersibility of a functional substance.

Further, the present invention can provide an ink composition which includes the block copolymer, has a satisfactory dispersibility of a coloring material and has a satisfactory fixability of the coloring material.

Additionally, the present invention can provide an ink-applying method and an ink-applying apparatus for stably ejecting the composition having a satisfactory dispersibility.

### BRIEF DESCRIPTION OF THE DRAWING

FIG. 1 is a block diagram illustrating the outline of structure of an image recording apparatus of the present invention.

### BEST MODE FOR CARRYING OUT THE INVENTION

Detailed description will be made below on the present invention.

The block copolymer of the present invention is a block copolymer composed of two or more segments, characterized in that at least one segment of the two or more segments is a gradient copolymer composed of two or more monomer components.

The block copolymer of the present invention is characterized in that at least one segment of the two or more segments is a gradient copolymer composed of two or more monomer components. Usually, in a segment composed of at least two or more monomer components, examples of the segment include a random copolymer, a block copolymer within the segment and an alternating copolymer, but the present invention requires a segment composed of a gradient copolymer.

The segment composed of a gradient copolymer means a segment composed of a copolymer in which a proportion between, for example, two monomer components forming the segment is distributed such that the monomer composition is varied with a slope from one end of the chain to the other end along the polymer chain of the segment, or distributed such that partially one monomer is varied in a larger amount and the other monomer is varied in a smaller amount, meaning, and it is called as a tapered copolymer.

Regarding a segment composed of the gradient copolymer, a polymerization reaction of a polymer can produce various kinds of gradient copolymers different in monomer distribution by varying the addition amounts, addition methods and addition time periods of tow or more monomer components. For example, such a polymerization can be carried out by adding a second monomer at an even rate or at a varying rate to a system in which the living polymerization of a first monomer is proceeding.

In the block copolymer of the present invention composed of two or more segments, the segments composed of the above-described gradient copolymer are combined with other segments to form blocks, and however, there is no limitation to the number and bonding positions of the segments composed of the gradient copolymer.

It is preferable that the block copolymer of the present invention is a triblock copolymer formed of an A, B and C segments (hereinafter referred to as ABC triblock copolymer), and the A segment is the above-described gradient copolymer.

Additionally, it is preferable that the ABC triblock copolymer is a triblock copolymer including at least one segment having a stimulus responsiveness, and the A segment is a gradient copolymer composed of at least two or more monomer components. It is more preferable that the ABC triblock copolymer is a triblock copolymer including at least one segment having responsiveness of varying a property thereof to a stimulus, the A segment is more hydrophobic than the B segment and the C segment, and the A segment is a gradient copolymer composed of two or more monomer components.

Description will be made below by taking as an example of the segment composed of a gradient copolymer in the present invention, a case of a block copolymer having the segment A, as one segment, composed of two components (a) and (b). As for the components forming the segment, it is assumed that, of the monomer (a) and the monomer (b) forming the segment A, a property possessed by the monomer (a) is affinity to a coloring material and a property possessed by the monomer (b) is solubility in a polymerization solvent. In this case, when the monomer (a) and the monomer (b) are added simultaneously and subjected to polymerization by means of a usual polymerization reaction, without controlling the configuration of the copolymer, it is general that a segment having a property intermediate between the properties of the two components is obtained. On the other hand, the segment composed of the gradient copolymer according to the present invention can have a property obtained by sloping the properties of both monomers in the segment. For example, when the segment A composed of a gradient copolymer is formed by carrying out polymerization under a rich proportion of the monomer (a) in the initial stage of the polymerization and then under a gradually increased proportion of the monomer (b), there can be obtained a segment structure in which one end (rich in the monomer (a)) of the gradient copolymer has a higher affinity to the coloring material and the other end (rich in the monomer (b)) of the polymer has an increased solubility in the polymerization solvent, and a segment structure which is composed of a component having a high bonding property of other segments to be bonded to the segment composed of the gradient copolymer.

In the present invention, preferably, at least one main chain skeleton of the segment(s) in the triblock copolymer has a polyvinyl ether structure. More preferably, at least one main chain skeleton of the segment(s) is composed of a structure represented by the following general formula (1):
General formula (1) 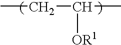
I wherein R¹ is selected from the group consisting of a straight chain, branched or cyclic alkyl group having 1 to 18 carbon atoms, —(CH(R²)—CH(R³)—O)₁—R⁴ or —(CH₂)ₘ—(O)ₙ—R⁴; 1 and m are independently selected from the integers of 1 to 12, and n is 0 or 1; R² and R³ are independently a hydrogen atom or CH₃; R⁴ is selected from the group consisting of a hydrogen atom, a straight chain, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵, and -PhCOOR⁵, and when R⁴ is a group other than a hydrogen atom, a hydrogen atom on a carbon atom of the group may be substituted by a straight chain or branched alkyl group having 1 to 4 carbon atoms, and a carbon atom in an aromatic ring of the group may be substituted by a nitrogen atom; R⁵ is a hydrogen atom or an alkyl group having 1 to 5 carbon atoms. Here, -Ph represents a phenyl group, -Pyr represents a pyrimidyl group, -Ph-Ph represents a biphenyl group, and -Ph-Pyr represents a pyrimidylphenyl group.

Additionally, it is preferable to use the block copolymer in which at least one of the segments contains a polymer having a polyvinyl ether structure. Methods for synthesizing a polymer containing a polyvinyl structure have been reported; a method of utilizing cation living polymerization, reported by Aoshima et al. (Japanese Patent Application Laid-Open Nos. H11-322942 and H11-322866) is representative of these methods. By conducting polymer synthesis utilizing the cation living polymerization, various polymers such as homopolymers, copolymers composed of two or more monomer components, block copolymers, graft polymers and gradient copolymers can be synthesized in such a way that the lengths (molecular weights) thereof are accurately regulated. Additionally, as for polyvinyl ether, in the side chains thereof, various functional groups can be introduced. Cation polymerization method can be carried out in other ways using an HI/I₂ system, an HCl/SnCl₄ system and the like.

In particular, it is preferable that the repeating structure unit of polyvinyl ether is a structure represented by the following general formula (1):
General formula (1) 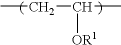
wherein R¹ is defined as described above.

In general formula (1), a straight chain or branched alkyl group means methyl, ethyl, n-propyl, i-propyl, n-butyl, sec-butyl, tert-butyl, pentyl, n-hexyl, heptyl, octyl, nonyl, decyl, undecyl, dodecyl, octadecyl and the like. Additionally, a cyclic alkyl group means cyclopropyl, cyclobutyl, cyclopentyl, cyclohexyl, cylooctyl and the like. When hydrogen atom(s) on carbon atom(s) of the these groups are substituted, substitution may be conducted either at one position or at plural positions.

Preferably, the repeating unit molecular structure, which contains a polyvinyl ether structure, in the polymer contained in the ink-jet ink having the above-described stimulus responsiveness is represented by the following general formula (2):
General formula (2) 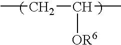
wherein R⁶ is selected from the group consisting of a straight chain, branched or cyclic alkyl group having 1 to 18 carbon atoms, -Ph, -Pyr, -Ph-Ph, -Ph-Pyr, —(CH₂—CH₂—O)₁—R⁷ and —(CH₂)ₘ—(O)ₙ—R⁷; a hydrogen atom in an aromatic ring of these groups may be substituted by a straight chain or branched alkyl group having 1 to 4 carbon atoms, and a carbon atom in an aromatic ring of these groups may be substituted by a nitrogen atom; 1 is selected from the integers of 1 to 18, m is selected from the integers of 1 to 36, and n is 0 or 1; R⁷ is selected from the group consisting of a hydrogen atom, a straight chain, branched or cyclic alkyl group having 1 to 18 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁸ and -PhCOOR⁸, and when R⁷ is a group other than hydrogen, a hydrogen atom on a carbon atom of the group may be substituted by a straight chain or branched alkyl group having 1 to 4 carbon atoms, F, Cl or Br, and a carbon atom in an aromatic ring of the group may be substituted by a nitrogen atom; R⁸ is a hydrogen atom or an alkyl group having 1 to 5 carbon atoms.

Preferably, R⁶ is selected from a group consisting of a straight chain, branched or cyclic alkyl group having 1 to 18 carbon atoms, -Ph, -Ph-Ph, —(CH₂—CH₂—O)₁—R⁷ and —(CH₂)ₘ—(O)ₙ—R⁷; a hydrogen atom in an aromatic ring of these groups may be substituted by a straight chain or branched alkyl group having 1 to 4 carbon atoms, and a carbon atom in an aromatic ring of these groups may be substituted by a nitrogen atom; 1 is selected from the integers of 1 to 18, m is selected from the integers of 1 to 36, and n is 0 or 1; R⁷ is selected from the group consisting of a hydrogen atom, a straight chain, branched or cyclic alkyl group having 1 to 18 carbon atoms, -Ph, -Ph-Ph, —CHO, —CO—CH═CH₂, —CO—C(CH₃)═CH₂, —CH₂COOR⁸ and -PhCOOR⁸, and when R⁷ is a group other than a hydrogen atom, a hydrogen atom on a carbon atom of the group may be substituted by a straight chain or branched alkyl group having 1 to 4 carbon atoms, F, Cl or Br, and a carbon atom in an aromatic ring of the group may be substituted by a nitrogen atom; R⁸ is a hydrogen atom or an alkyl group having 1 to 5 carbon atoms.

More preferably, as the repeating unit molecular structure in the above described polymer which contains a polyvinyl ether structure, vinyl ether monomer structures are shown below, but the polyvinyl ether structures to be used in the present invention are not limited to the following structures.

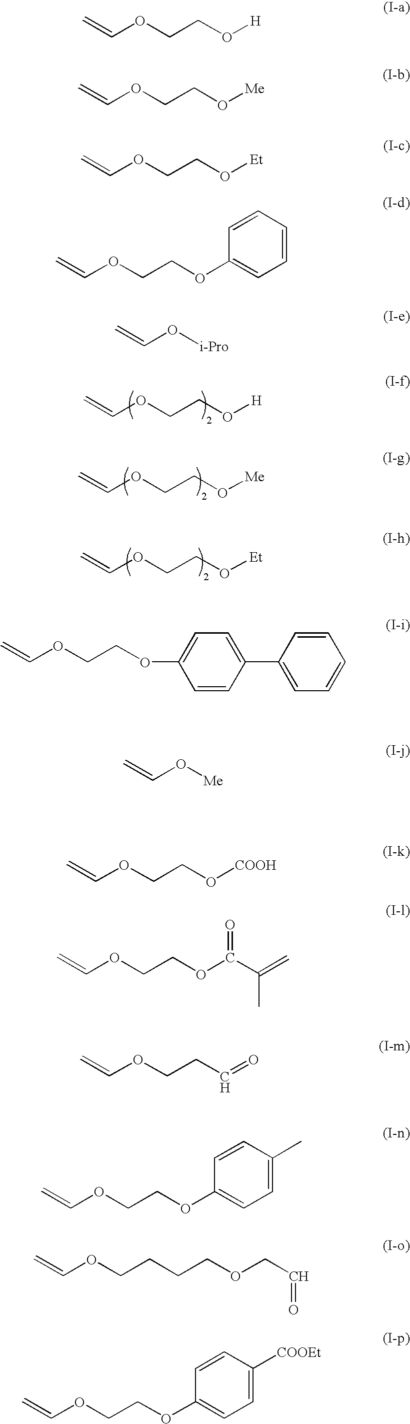

In the present invention, block copolymers containing polyvinyl ether structures, composed of these vinyl ether monomers, can be suitably used. The block copolymers which can be used in the present invention are block copolymers containing polyvinyl ether structures having stimulus responsiveness, composed of the above-described vinyl ether monomers, but are not limited to these block copolymers.

Examples of the block copolymers include the following block copolymers, but the block copolymers to be used in the present invention are not limited to the following block copolymers.

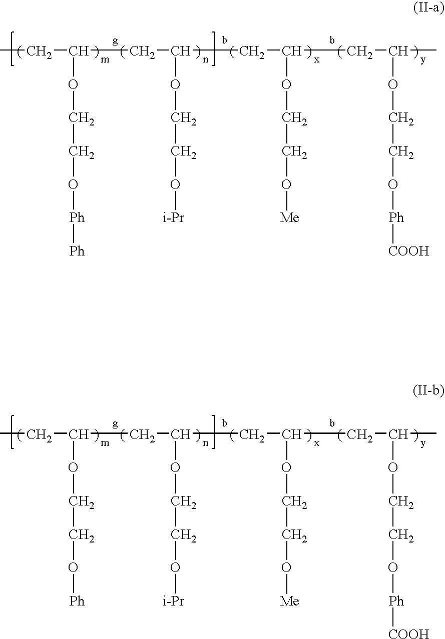

In these structural formulas, b and g represent bonding forms, respectively meaning block and gradient.

Additionally, it is preferable that the numbers of repeating units of polyvinyl ether (x, y, m and n in the above (II-a) to (II-b)) are independently 1 or more and 10,000 or less; and it is also preferable that the sums of the numbers ((x+y+m+n) in the above (II-a) to (II-b)) are 10 or more and 40,000 or less.

For the cases where the B and C segments in the block copolymer containing polyvinyl ether structure are independently composed of two or more kinds of monomers, the segments each may be a random polymer or a gradient polymer.

Additionally, the number average molecular weight of the block copolymer is 1,000 to 1,000,000, more preferably 2,000 or more to 500,000 or less. When the number average molecular weight is less than 1,000, the stimulus responsiveness and some desired functions of the block copolymer are degraded, and when the molecular weight is excessively larger than 1,000,000, the solubility of the block copolymer in a solvent is degraded, so that such a molecular weight of larger than 1,000,000 or smaller than 1,000 is not satisfactory from the viewpoint of practical properties.

For the purpose of displaying the stimulus responsiveness possessed by the block copolymer, it is advantageous that the molecular weight distribution of the block copolymer (weight average molecular weight/number average molecular weight=Mw/Mn) is small, and therefore the molecular weight distribution is preferably 1.8 or less, more preferably 1.6 or less, further more preferably 1.3 or less, and yet further more preferably 1.2 or less.

Lowering of the glass transition temperature makes the molecular structure flexible, and improves affinity to coloring materials, so that the glass transition temperature of at least one of the segments of the block copolymer is preferably 20° C. or less, more preferably 0° C. or less, and more preferably −20° C. or less. Also form this viewpoint, the use of a polymer containing a polyvinyl ether structure is a preferred mode.

Additionally, the ink composition of the present invention can be made to have responsiveness to stimuli. A stimulus is applied in image forming process through the stimulus responsiveness to increase the viscosity of the ink composition and thereby obtain satisfactory fixability of the ink composition. The stimulant species to be applied are appropriately selected for image formation from the group consisting of cation, temperature variation, exposure to electromagnetic wave, pH variation, concentration variation and the like.

The composition containing a polymer dispersing a functional substance according to the present invention can vary a state (property) thereof in response to various stimuli. In the present invention, examples of the “stimuli” can include cation addition, temperature variation, electric filed application, exposure to light (electromagnetic wave) such as ultraviolet light, visible light and infrared ray, pH variation of the composition, addition of chemical substances, and concentration variation of the composition.

For instance, when a cation is added, it is possible to vary the solubility of the polymer in a solvent. Introduction of a nonionic or an anionic repeating unit structure into the structure of the block copolymer of the present invention makes it possible to cause an electric attraction force to increase the viscosity of the ink, thereby achieving a satisfactory fixability.

In the present invention, the preferable stimuli include the following stimuli in addition to the above-described cation addition. Firstly, there is temperature variation, and the range of the temperature variation is a range including the phase transition temperature of the composition and the vicinity of the phase transition temperature. Secondly, there is exposure to electromagnetic wave, and it is preferable that the wavelength range of the electromagnetic wave is from 100 to 800 nm. Thirdly, there is pH variation of the composition, and it is preferable that the pH variation range is from pH 3 to pH 12. Fourthly, there is concentration variation of the composition, and there is a case in which the concentration of the composition is varied, for example, by evaporation or absorption of the solvent of the composition, or by varying the concentration of the polymer dissolved in the composition. It is preferable that the concentration variation is in a range including the concentration at which the composition exhibits the phase transition and the vicinity of the concentration. In the present invention, two or more types of stimuli may be combined and applied.

Examples of the state variation caused by the response to a stimulus can include the phase transition form a sol state to a gel state, the phase transition from a solution state to a solid state, and chemical structure changes. Additionally, the “stimulus responsiveness” in the present invention means that a property of the composition of the present invention is varied in response to such a stimulus as described above. More specifically, the stimulus responsiveness means a remarkable variation of shape or a physical property of the composition in response to a stimulus (environmental variation), applied to the composition, such as temperature variation, electric field application, exposure to electromagnetic wave, pH variation, addition of a chemical substance or concentration variation of the composition.

A second aspect of the present invention is a polymer-containing composition wherein the composition includes the above-described block copolymer, a solvent or a dispersion medium, and a functional substance. Preferably, the polymer-containing composition includes the block copolymer, a functional material, a solvent or a binder resin.

For the block copolymer, the above-described block copolymer is used. The content of the block copolymer falls in the range from 0.1 to 40% by mass, and preferably in the range from 0.5 to 30% by mass in relation to the total weight of the polymer-containing composition.

As the functional substance, there can be used medical drugs, cosmetics, magnetic materials and the like; particularly, it is a preferred embodiment to use coloring materials. The content of the functional substance fall in the range from 0.1 to 40% by mass, and preferably in the range from 0.5 to 30% by mass, in relation to the total weight of the polymer-containing composition.

Preferably, water or aqueous solvents are used for the solvent or dispersion medium contained in the polymer-containing composition of the present invention.

[Water]

As water contained in the polymer-containing composition of the present invention, ion-exchanged water free from metal ions and the like, pure water and ultrapure water are preferable.

[Aqueous Solvents]

As the aqueous solvents, it is possible to use, for example, polyalcohols such as ethylene glycol, diethylene glycol, triethylene glycol, polyethylene glycol, propylene glycol, polypropylene glycol and glycerin; polyalcohol ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidones and triethanolamine. Additionally, monoalcohols such as methanol, ethanol and isopropyl alcohol can also be used.

In the polymer-containing composition of the present invention, the above-described water and aqueous solvents each are used preferably in the content range from 20 to 99.9% by mass, more preferably in the range from 30 to 99% by mass, in relation to the total weight of the polymer-containing composition.

In the polymer containing composition of the present invention, the functional substance is enfolded by the block copolymer and dispersed in a solvent or in a dispersion medium; the block copolymer has a function of dispersion stabilization.

Incidentally, the enfoldment in the present invention means a state that a functional substance is covered with the above-described block copolymer.

A preferred embodiment of the present invention is a functional substance dispersing composition in which the functional substance and the block copolymer are dispersed in a particle form into a solvent or a dispersion medium; however, the present invention is not limited to this composition.

A third aspect of the present invention is an ink composition wherein the composition includes the above-described block copolymer, solvent or dispersion medium and coloring material. Preferably, the ink composition includes the block copolymer, coloring material and water-soluble solvent, and a preferred embodiment is to use the ink composition as an ink-jet ink composition.

A preferred embodiment of the present invention is an ink composition in which the coloring is enfolded by the block copolymer and dispersed in a particle form into a solvent; however, the present invention is not limited to this composition.

For the block copolymer contained in the ink composition of the present invention, the above described block copolymer is used. It is desirable that the content of the block copolymer contained in the ink composition of the present invention is 0.1 to 50% by mass, preferably 0.5 to 30% by mass, in relation to the total weight of the ink composition. When the content of the block copolymer is less than 0.1% by mass, the coloring material contained in the ink composition of the present invention cannot be sufficiently dispersed in the composition in some cases, while when the content exceeds 50% by mass, the viscosity of the composition becomes too large in some cases.

Preferably, water or aqueous solvents are used for the solvent or dispersion medium contained in the ink composition of the present invention.

[Water]

As water contained in the ink-jet ink of the present invention, ion-exchanged water free from metal ions and the like, pure water and ultrapure water are preferable.

[Aqueous Solvents]

As the aqueous solvents, it is possible to use, for example, polyalcohols such as ethylene glycol, diethylene glycol, triethylene glycol, polyethylene glycol, propylene glycol, polypropylene glycol and glycerin; polyalcohol ethers such as ethylene glycol monomethyl ether, ethylene glycol monoethyl ether, ethylene glycol monobutyl ether, diethylene glycol monoethyl ether and diethylene glycol monobutyl ether; and nitrogen-containing solvents such as N-methyl-2-pyrrolidone, substituted pyrrolidones and triethanolamine. Additionally, for the purpose of accelerating the drying of the ink-jet ink on the recording medium, monoalcohols such as methanol, ethanol and isopropyl alcohol can also be used.

In the ink composition of the present invention, the above-described water and aqueous solvents each are used preferably in the content range from 20 to 95% by mass, more preferably in the range from 30 to 95% by mass, in relation to the total weight of the ink composition.

[Coloring Materials]

Useful coloring materials in the present invention may be either liquid or solid depending on the intended application of the ink composition of the present invention, preferably depending on the intended application of the ink-jet ink of the present invention; a solid dye dissolved in a solvent may be used, and pigments and dyes are preferable.

The pigments may be either organic pigments or inorganic pigments; for pigments to be used for ink, preferably, black pigments and cyan, magenta, yellow, red, green and blue primary pigments can be used. Incidentally, color pigments, achromatic or hypochromic pigments, metallic luster pigments and the like, other than those described above, may also be used. Additionally, pigments newly synthesized for the present invention may also be used. Additionally, the used pigments preferably have 50 nm in average primary particle size; commercially available pigments can be used, and pigments having been pulverized (for example, mechanical crushing by milling) and sorted can also be used.

Examples of commercially available black, cyan, magenta and yellow pigments are shown below. Examples of black pigments can include Raven 1060 (manufactured by Columbian Carbon Co.), MOGUL-L (manufactured by Cabot Corp.), Color Black FW1 (manufactured by Degussa Co.) and MA 100 (manufactured by Mitsubishi Chemical Corp.), but the black pigments are not limit to these examples.

Examples of the cyan pigments include C. I. Pigment Blue-15:3, C. I. Pigment Blue-15:4, and C. I. Pigment Blue-16, but the cyan pigments are not limited to these examples.

Examples of the magenta pigments include C. I. Pigment Red-122, C. I. Pigment Red-123, and C. I. Pigment Red-146, but the magenta pigments are not limited to these examples.

Examples of the yellow pigments include C. I. Pigment Yellow-74, C. I. Pigment Yellow-128, and C. I. Pigment Yellow-129, but the yellow pigments are not limited to these examples.

It is preferable that the content of a pigment to be used in the ink composition of the present invention is 0.1 to 50% by mass in relation to the total weight of the ink composition. When the content of the pigment is less than 0.1% by mass, sufficient image density cannot be obtained, while when the content exceeds 50% by mass, image fixability is sometimes degraded. A range from 0.5% by mass to 30% by mass is more preferable.

Additionally, in the cases of dyes to be used by dissolving in solvents, water-soluble dyes and oil-soluble dyes can be appropriately used. It is preferable that the content of a dye to be used in the ink composition of the present invention is 0.1 to 50% by mass in relation to the total weight of the ink composition. Additionally, the dyes which can be used in the ink composition of the present invention, preferably the ink-jet ink of the present invention may be dyes well known in the art; thus, there can be used direct dyes, acidic dyes, basic dyes, reactive dyes, water-soluble dyes of coloring matters for a food, and oil-soluble dyes.

Specific examples of the dyes to be used in the ink composition such as the ink-jet ink according to the present invention are shown below.

Examples of water-soluble dyes include:

direct dyes such as C. I. Direct Black-17, -62, -154; C. I. Direct Yellow-12, -87, -142; C. I. Direct Red-1, -62, -243; C. I. Direct Blue-6, -78, -199; C. I. Direct Orange-34, -60; C. I. Direct Violet-47, -48; C. I. Direct Brown-109; C. I. Direct Green-59:

acidic dyes such as C. I. Acid Black-2, -52, -208; C. I. Acid Yellow-11, -29, -71; C. I. Acid Red-1, -52, -317; C. I. Acid Blue-9, -93, -254; C. I. Acid Orange-7, -19; C. I. Acid Violet-49:

reactive dyes such as C. I. Reactive Black-1, -23, -39; C. I. Reactive Yellow-2, -77, -163; C. I. Reactive Red-3, -111, -221; C. I. Reactive Blue-2, -101, -217; C. I. Reactive Orange-5, -74, -99; C. I. Reactive Violet-1, -24, -38; C. I. Reactive Green-5, -15, -23; C. I. Reactive Brown-2, -18, -33:

C. I. Basic Black-2; C. I. Basic Red-1, -12, -27; C. I. Basic Blue-1, -24; C. I. Basic Violet-7, -14, -27; C. I. Food Black-1, -2.

Additionally, examples of oil-soluble dyes include Oil Orange 201, Oil Orange PR, Oil Brown BB, Oil Brown GR, Oil Brown 416, Oil Green 502, VALIFAST GREEN 1501, VALIFAST GREEN 2520, Oil Yellow 129, Oil Yellow GGS, Oil Black 860, Oil Black BS, Oil Black HBB, and Oil Black BY.

Incidentally, these above-described examples of liquid coloring materials are particularly preferable for the ink-jet ink of the present invention; however, the liquid coloring materials to be used in the ink-jet ink of the present invention are not limited to the above-described dyes.

It is preferable that the content of a liquid dye to be used in the ink composition such as the ink-jet ink of the present invention is 0.1 to 50% by mass in relation to the total weight of the ink composition. When the content of the dye is less than 0.1% by mass, suff icient image density cannot be obtained, while when the content exceeds 50% by mass, image fixability is sometimes degraded. A range from 0.5% by mass to 30% by mass is more preferable.

[Additives]

Various additives and auxiliary agents can be added according to need to the ink composition of the present invention.

As one of the additives for the ink composition of the present invention, there is a dispersion stabilizer which stably disperses polymer micelles in a solvent. The ink composition of the present invention has a function to stably disperse with the aid of the polymer which contains the polyvinyl ether structure; however, if dispersion is insufficient, other dispersion stabilizers may be added.

As other dispersion stabilizers, resins or surfactants having both hydrophilic and hydrophobic portions can be used.

The resins having both hydrophilic and hydrophobic portions include, for example, copolymers formed of hydrophilic monomers and hydrophobic monomers. Examples of the hydrophilic monomers are acrylic acid, methacrylic acid, maleic acid, fumaric acid, monoesters of these carboxylic acids, vinyl sulfonic acid, styrene sulfonic acid, vinyl alcohol, acrylamide and methacryloxyethyl phosphate. Examples of the hydrophobic monomers are styrene, styrene derivatives such as α-methylstyrene, vinylcyclohexane, vinylnaphthalene derivatives, acrylates and methacrylates. As the copolymers, there can be used copolymers having various structures such as random, block, and graft copolymers. Needless to say, the hydrophilic monomers and the hydrophobic monomers to be used are not limited to the above-described examples.

As the surfactants, there can be used anionic, nonionic, cationic and amphoteric surfactants.

Examples of the anionic surfactants include fatty acid salts, alkylsulfuric ester salts, alkylarylsulfonates, alkyldiaryl ether disulfonates, dialkylsulfosuccinates, alkylphosophates, naphthalenesulfonic acid-formalin condensate, polyoxyethylenealkylphosphoric ester salts, and glycerol borate fatty acid ester.

Examples of the nonionic surfactants include polyoxyethylene alkyl ether, polyoxyethylene-oxyporpylene blockcopolymer, sorbitan fatty acid esters, glycerin fatty acid esters, polyoxyethylene fatty acid esters, polyoxyethylene alkylamines, fluorine-based surfactants and silicon-based surfactants.

Examples of the cationic surfactants include alkylamine salts, quaternary ammonium salts, aklylpyridinium salts and alkylimidazolium salts.

Examples of amphoteric surfactants include alkylbetaines, alkylamine oxides and phosphadylcholines. Incidentally, the surfactants to be used are also not limited to the above-described surfactants.

Additionally, to the ink composition of the present invention, an aqueous solvent can be added according to need. In particular, when the ink composition is used for ink-jet ink, an aqueous solvent is used for the purpose of preventing the drying and hardening of ink in the nozzle region; an aqueous solvent alone, or a mixture of aqueous solvents can be used. As for the aqueous solvents, the above-described aqueous solvents, as they are, are applicable. The content of an aqueous solvent falls in the range from 0.1 to 60% by mass, more preferably from 1 to 25% by mass, in relation to the total weight of the ink.

As other additives, there can be added pH adjusters for stabilizing the ink-jet ink and ensuring the stability of the piping for ink-jet ink, penetrants for promoting the penetration of ink into the recording medium to accelerate apparent drying, antimold agents for preventing mold generation in ink, chelating agents for blockading metal ions in ink to prevent metal deposition in the nozzle region and precipitation of insoluble substances in ink, antifoaming agents for preventing foam generation in the circulation, transfer and production of the recording liquid, antioxidants, antimold agents, viscosity adjusters, electric conduction agents, ultraviolet light absorbers; and water-soluble dyes, dispersion dyes, oil-soluble dyes and the like.

The above-described ink composition of the present invention is suitable as ink-jet ink.

Description will be made below on the specific details of the ink-jet ink (aqueous dispersion ink) that is a preferred embodiment of the ink composition of the present invention.

[Production Method of the Ink-Jet Ink]

The production method of the ink-jet ink includes, as a preferred embodiment using a coloring material and a block copolymer, a method of producing an ink-jet ink by the steps of dispersing or dissolving the coloring material in an organic solvent, adding the solution thus obtained to an aqueous solution containing the block copolymer dispersed or dissolved therein, and then removing the organic solvent. However, the production method of the present invention is not limited to the above-described method.

As an example of dispersing the block copolymer, for example, a triblock copolymer, there is a dispersion using a dispersion apparatus, and examples of the dispersion apparatus include a supersonic homogenizer, a laboratory homogenizer, a colloid mill, a jet mill and a ball mill. These apparatuses may be used each alone or in combinations thereof.

The fourth aspect of the present invention is an ink-applying method characterized in that the method includes a step of applying the above-described ink composition to a medium. More specifically, it relates to a method of using a composition including the block copolymer, the functional substance, and a solvent or a binder resin, and applying the composition. More preferably, the method is a liquid-applying method of using an ink composition characterized in that the composition includes a block copolymer, a coloring material, and a water-soluble solvent. A recording method using the ink composition as the ink-jet ink composition is a preferred embodiment.

Additionally, a fifth aspect of the present invention is an ink-applying apparatus, wherein the apparatus includes an ink-applying means for applying ink onto a medium by energizing the ink composition, and a drive means for driving the ink-applying means. More specifically, it relates to an apparatus for using a composition characterized in that the composition includes the block copolymer, the functional substance, and the solvent or the binder resin, and applying the composition. More preferably, the apparatus is a liquid-applying apparatus which uses the ink composition wherein the composition includes the block copolymer, the coloring material, and the water-soluble solvent. A recording apparatus using the ink composition as the ink-jet ink composition is a preferred embodiment. Description will be made below on an image-forming method and an image-forming apparatus, as specific examples of the ink-applying method and the ink-applying apparatus of the present invention.

[Image-Forming Method and Image-Forming Apparatus]

The ink-jet ink of the present invention can be used for various image-forming apparatuses utilizing a printing method, an ink-jet method, an electrophotographic method or the like, and drawing can be made by an image-forming method using these apparatuses.

In the present invention, an ink-jet printer using ink-jet ink includes various ink-jet recording apparatuses such as of a piezo ink-jet system using piezoelectric elements and a thermal ink-jet system in which thermal energy is applied to ink to bubble the ink, thereby carrying out recording.

In the apparatus of the present invention, for example, in the case of an ink-jet ink, it is preferable that the amount of ink ejected from the ejection orifice of an ejection head falls within the range from 0.1 picoliter to 100 picoliters, for the purpose of improving image resolution.

In particular, in the case of an ink-jet recording apparatus, the recording apparatus of the present invention has, as one embodiment thereof, means for bringing the ink-jet ink into contact with a composition containing an additive (crosslinking agent) for crosslinking with the block copolymer as a composition exerting a stimulus for varying the solvent environment. In this embodiment, the ink-jet ink is fixed on the recording medium by this contact to form an excellent image.

Additionally, the ink-jet ink of the present invention can be used for an indirect recording apparatus using a recording system in which ink is printed onto an intermediate transferring member and then transfer the ink onto a recording medium such as a sheet of paper. Also, the ink-jet ink can be applied to an apparatus utilizing an intermediate transferring member by a direct recording system.

In particular, the ink-jet ink of the present invention can be used for an image-forming method and an image-forming apparatus utilizing the electrophotographic recording system. As the image forming apparatus concerned, for example, there is an apparatus provided with a photosensitive drum for forming a latent image, means (exposure apparatus or the like) for forming a latent image on the drum, an ink-applying means, a transferring mechanism and a recording medium. In the image formation by means of this apparatus, firstly a latent image is formed on the photosensitive drum, the ink-jet ink of the present invention is applied onto the latent image or the portion other the latent image, and the image thus obtained is transferred onto the recording medium by means of the transferring mechanism, and then fixed.

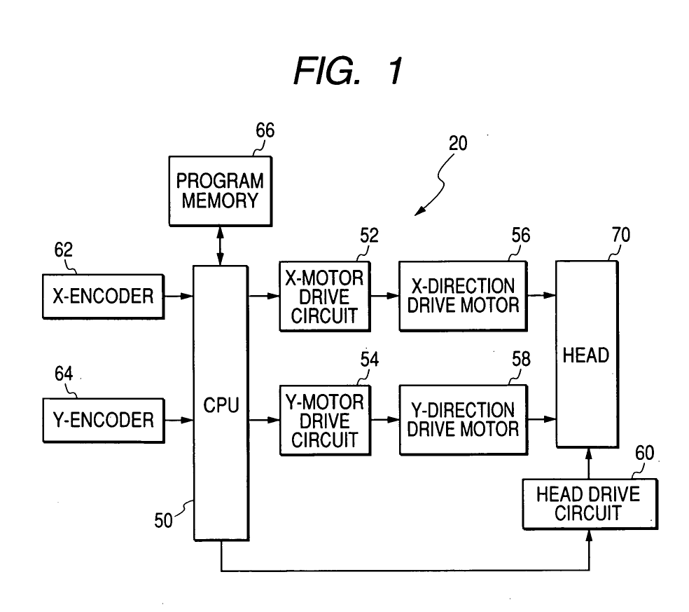

Description will be made below on the outline of the ink-jet recording apparatus with reference to FIG. 1. However, FIG. 1 shows an example of configuration, but the present invention is not limited to it.

FIG. 1 is a block diagram illustrating the configuration of the ink-jet recording apparatus.

FIG. 1 illustrates a case in which a head is moved for recording on the recording medium. In FIG. 1, an X-direction drive motor 56 and a Y-direction drive motor 58 for driving a head 70 to xy-directions are connected to CPU 50 for controlling the whole operation of the recording apparatus through an X-motor drive circuit 52 and a Y-motor drive circuit 54, respectively. Following instructions issued by CPU, the X-direction drive motor 56 and the Y-direction drive motor 58 are driven through the X-motor drive circuit 52 and the Y-motor drive circuit 54, respectively, thus determining the position of the head 70 in relation to the recording medium.

As shown in FIG. 1, a head drive circuit 60 is connected to the head 70, in addition to the X-direction drive motor 56 and the Y-direction drive motor 58; CPU 50 controls the head drive circuit 60, and thus carries out the drive of the head 70, namely, ejection of ink-jet ink and the like. Additionally, for the purpose of detecting the position of the head, an X-encoder 62 and a Y-encoder 64 are connected to CPU 50, and the position information of the head 70 is input thereinto. Additionally, a control program is input into a program memory 66. CPU 50 moves the head 70 on the basis of the control program and the position information from the X-encoder 62 and the Y-encoder 64, to locate the head at a desired position on the recording medium, and ink-jet ink is ejected. In such a manner, a desired drawing can be carried out on the recording medium. Additionally, in the case of an image-recording apparatus which permits loading a plurality of ink-jet inks, a desired drawing can be made on a recording medium by repeating such an operation as described above for each of the ink-jet inks for a predetermined number of times.

Additionally, it is also possible that after ink-jet ink has been ejected, according to need, the head 70 is moved to a position where a removing means (not shown in the figure) for removing the surplus ink attached to the head is arranged, and the head 70 is cleaned by wiping or the like. As the specific method for cleaning, conventional methods can be used without any modification.

On completion of drawing, a delivery mechanism, not shown in the figure, of the recording medium replaces the drawn recording medium with a new recording medium.

Additionally, the present invention allows any modification or transformation of the above-described embodiment as far as the modification or the transformation does not deviate from the gist of the present invention. For instance, in the above description, there have been presented an example in which the head 70 is moved along the X and Y directions; however, drawing may also be made by coupling the following two movements, namely, the movement of the head only along X direction (or Y direction) and the movement of the recording medium along the Y direction (or X direction).

The ink jet recording apparatus of the present invention includes means for generating thermal energy (for example, an electrothermal transducer or a laser) as the energy source to be used in ejecting an ink-jet ink, and a head which ejects the ink-jet ink with the aid of the above-described thermal energy provides an excellent effect. Such a system makes it possible to achieve high precision drawing. The use of the ink-jet ink of the present invention makes it possible to carry out a further excellent drawing.

Regarding typical configuration and principle of the above-described apparatus provided with means for generating thermal energy, preferable is an apparatus in which a fundamental principle disclosed in, for example, U.S. Pat. Nos. 4,723,129 and 4,740,796 is utilized. This system based on this principle can be applied to either of an on-demand type recording head and a continuous type recording head; in particular, the system is effective when applied to the on-demand type recording head because by applying at least one drive signal, corresponding to the ejection information and causing a sharp temperature rise exceeding nuclear boiling, to an electrothermal transducer holding liquid and located so as to face a liquid flow path, the electrothermal transducer is made to generate thermal energy and film boiling is thereby caused on a thermal action surface of the head, and consequently, a bubble can be formed in the liquid in one-to-one correspondence to this drive signal. The growth and contraction of the bubble allow the liquid be ejected through the ejection orifice so as to form at least one droplet. More preferably, when the drive signal is shaped into a pulse, a bubble is instantaneously and properly grown and contracted, so that a liquid ejection particularly excellent in response can be achieved. As the pulse shaped drive signal, such signals as disclosed in U.S. Pat. Nos. 4,463,359 and 4,345,262 are suitable. Incidentally, a more excellent ejection can be performed in the case of adopting the conditions described in U.S. Pat. No. 4,313,124, an invention related to the temperature rise on the above-described thermal action surface.

In addition to such structures, as disclosed in the above-described patents, composed of a combination of an ejection orifice, a liquid-channel and an electrothermal transducer (liner liquid flow path or right-angled liquid flow path), the present invention includes the structure disclosed in U.S. Pat. No. 4,558,333 in which the thermal action portion is arranged in a bent portion, and the structure of U.S. Pat. No. 4,459,600. Additionally, the effect of the present invention is effective when adopting a structure disclosed in Japanese Patent Application Laid-Open No. S59-123670 in which a slit common to a plurality of electrothermal transducers is used as the ejection portion of the electrothermal transducers, and also when adopting a structure disclosed in Japanese Patent Application Laid-Open No. S59-138461 in which an opening absorbing the pressure wave of the thermal energy is made to correspond to the ejection portion. In other words, whatever is the form of the head, according to the present invention, ejection of an ink-jet ink can be efficiently carried out without fail.

Additionally, the present invention can be applied to a full-line-type recording head having the length corresponding to the maximum width of the recording medium in the image-forming apparatus of the present invention. Such a head may have either of a structure in which a plurality of heads are combined to fill the length and a structure in which the head has a form integrated into one piece.

Additionally, the present invention is effective even for serial type heads such as a head fixed to the apparatus body or a freely exchangeable chip type head which can be electrically connected to the apparatus body and supplied with ink from the apparatus body by being installed in the apparatus body.

Additionally, the apparatus of the present invention may further include a droplet removing means. When added with such means, a more excellent ejection effect can be achieved.

Additionally, it is preferable that the structure of the apparatus of the present invention is added with additional auxiliary means and the like because the effect of the present invention can be further stabilized. Specific examples of such means include the following means for the head: a capping menas; a pressurizing or sucking means; a spare heating means by use of an electrothermal transducer or a heating element other than this, or a combination of these; and a preliminary ejection means for carrying out ejection other than the ink ejection orifice.

Implementation of the above-described film boiling system is most effective for the present invention.

Detailed description will be made below on the present invention on the basis of Examples, but the present invention is not limited to these Examples. In the following Examples, description will be made on a method for synthesizing the block copolymer of the present invention, and on the ink-jet ink of the present invention by taking a dispersed dye ink-jet ink as an example of the ink-jet ink. Incidentally, these Examples involving the polymer synthesis and the dispersion dye inks describe some specific examples of the examples actually carried out, but the present invention is not limited these to be described examples.

### EXAMPLE 1

<Synthesis of ABC triblock copolymer: synthesis of a triblock copolymer composed of isobutylvinyl ether and CH₂═CHOCH₂CH₂OPhPh (IBVE-g-BPhOVE: A block), 2-methoxyethyl vinyl ether (MOVE: B block), and 4-(2-vinyloxy)ethoxybenzoic acid (HBVE: C block), namely poly[(IBVE-g-BPhOVE)-b-MOVE-g-HBVE] (II-a)> (Here, b is a symbol standing for a block copolymer and g is a symbol standing for a gradient polymer.)

After the interior of a glass vessel equipped with a three-way cock had been substituted by a nitrogen gas, the vessel was heated to 250° C. in an atmosphere of a nitrogen gas to remove the adsorbed water. The system was allowed to be brought back to room temperature, 6 mmol of BPhOVE, 16 mmol of ethyl acetate, 0.1 mmol of 1-isobutoxyethyl acetate and 11 ml of toluene were placed in the vessel, and thereafter the reaction system was cooled. When the system temperature reached 0° C., 0.2 mmol of ethyl aluminium sesquichloride (an equimolecular mixture of diethyl aluminium chloride and ethyl aluminium dichloride) was added, and polymerization was started. Subsequently, a total amount of 6 mmol of IBVE was added to the system slowly over a time period of 24 hours, and the molecular weight was monitored in a time division mode by means of molecular sieve column chromatography (GPC) and NMR, verifying the completion of the polymerization of the A block and the formation of the gradient structure of the copolymer.

Then, as the B block component, 24 mmol (millimol) of MOVE was added, and the polymerization was continued. The molecular weight was monitored in. a time division manner by means of molecular sieve column chromatography (GPC) and NMR, and thus the completion of the B block polymerization and the formation of the AB diblock copolymer were verified.

Then, a toluene solution of 2.0 mmol of ethyl 4-(2-vinyloxy)ethoxybenzoate was continuously added, and thus the polymerization was continued. After 24 hours, the polymerization reaction was terminated. The termination of the polymerization reaction was carried out by adding a 0.3% by mass of aqueous ammonia/methanol. The reaction mixture solution was diluted with dichloromethane, washed three times with 0.6 mol/L hydrochloric acid, then washed three times with distilled water, and thus, a triblock copolymer was obtained.

Identification of the triblock copolymer was made with NMR and GPC, obtaining Mn=23000, Mw/Mn=1.24, and the polymerization ratio A:B:C=100:200:30. The polymerization ratio between the two monomers in the A block was 1:1, the proportion of the IBVE repeating unit structure in relation to BPhOVE was increased with increasing extent of polymerization as revealed by the NMR measurements of the produced polymer carried out at various times in the course of progressing polymerization; consequently, there was verified a synthesis of a block copolymer in which the monomer composition was gradually varied along the polymer chain.

The triblock copolymer thus obtained was further subjected to hydrolysis in an aqueous mixed solution of dimethylformamide and sodium hydroxide, and ethyl 4-(2-vinyloxy)ethoxybenzoate in the C block component was thereby hydrolyzed to obtain a triblock copolymer transformed into a sodium salt, namely, a triblock copolymer in which the C segment was a hydrophilic block segment composed of a repeating unit structure with anionic property. Identification of the compound was carried out by means of NMR and GPC.

Additionally, by neutralization with 0.1 N hydrochloric acid in the aqueous dispersion, there was obtained poly[(IBVE-g-BPhOVE)-b-MOVE-b-4-(2-vinyloxy)ethoxybenzoic acid]], this compound being a triblock copolymer in which the 4-(2-vinyloxy)ethoxybenzoic acid in the C block component is a free carboxylic acid. Identification of the compound was carried out by means of NMR and GPC.

### EXAMPLE 2

An ink composition was obtained as follows: 13 parts by mass of the above-described triblock copolymer and 5 parts by mass of an oil-soluble dye, Oil Blue N (brand name, manufactured by Aldrich Co.) were simultaneously dissolved into 20 parts by mass of dimethylformaide, and then the solution thus obtained was converted to an aqueous phase with 40 parts by mass of distilled water to obtain the ink composition. To this ink composition, 0.1 ml of 1N sodium hydroxide was added, further treated with a supersonic homogenizer for 10 minutes, and then allowed to stand for 1 hour. The dispersion thus obtained responded to a strip of pH test paper to give pH 12, and was found to be very transparent and blue. Even after the dispersion had been allowed to stand for 10 days, neither separation nor precipitation of the oil-soluble dye was found to occur.

The ink composition obtained as described above was filled in a printing head of an ink-jet printer (BJF800, manufactured by Canon Inc.), and was ejected onto a recording medium to obtain an image. For the recording medium, plain paper was sprayed with hydrochloric acid, and thus a recording medium susceptible to stimuli was prepared. By use of the following methods (1) and (2), the recording medium and the dispersion composition were evaluated.

(1) By use of the above-described printer, a 50 mm×50 mm square was printed solidly, and after an elapsed time of 30 seconds from the printing, a finger was strongly pressed onto the recorded portion, but no ink stuck to the finger.

(2) By use of the above-described printer, a 50 mm×50 mm square was printed solidly, and after an elapsed time of 30 seconds from the printing, the printed image was strongly rubbed 5 times with a line marker, but no blue tailing was observed.

### COMPARATIVE EXAMPLE 1

A water-soluble dye ink which was very transparent and blue was obtained by stirring 4 parts by mass of a water-soluble dye, C. I. Direct Blue-199, and 17 parts by mass of ethylene glycol in 79 parts by mass of distilled water. As recording media, the plain paper sprayed with hydrochloric acid, prepared in Example 2, and plain paper with no spray were used. Evaluation was carried out in the same manner as in Example 2.

(1) By use of the above-described printer, a 50 mm×50 mm square was printed solidly, and after an elapsed time of 30 seconds from the printing, a finger was strongly pressed onto the recorded portion; both in the case where the plain paper sprayed with hydrochloric acid was used as the recording medium and in the case where the plain paper with no spray was used as the recording medium, ink stuck to the finger. (2) By use of the above-described printer, a 50 mm×50 mm square was printed solidly, and after an elapsed time of 30 seconds from the printing, the printed image was strongly rubbed once with a line marker; both in the case where the plain paper sprayed with hydrochloric acid was used as the recording medium and in the case where the plain paper with no spray was used as the recording medium, blue tailing was observed.

### INDUSTRIAL APPLICABILITY

According to the present invention, there can be provided a block copolymer having a segment formed of a gradient copolymer which is composed of at least two or more monomer components, and capable of satisfactorily dispersing a functional substance in a solvent.

Additionally, the block copolymer of the present invention in which has a satisfactory dispersibility of a functional substance or a coloring material can be used as an ink composition having a satisfactory fixability of the coloring material, and can be preferably used as an ink-jet ink.

Additionally, the liquid-applying method and the liquid-applying apparatus of the present invention which stably eject the ink-jet ink having a satisfactory dispersibility of a coloring material can be utilized as an ink-jet recording method and an ink-jet recording apparatus, respectively.

This application claims priority from Japanese Patent Application No. 2003-375387 filed Nov. 5, 2003, which is hereby incorporated by reference herein.

1. A block copolymer comprising two or more segments, wherein at least one of the segments is a gradient copolymer comprising two or more monomer components.

2. The block copolymer according to claim 1, wherein the block copolymer is a triblock copolymer comprising A, B and C segments and the A segment is the gradient copolymer.

3. The block copolymer according to claim 2, wherein the A segment is higher in hydrophobicity than the B segment and the C segment.

4. The block copolymer according to claim 1, wherein the at least one of the segments has a responsiveness of varying a property thereof to a stimulus.

5. The block copolymer according to claim 1, wherein at least one main chain skeleton of the segment(s) is a polyvinyl ether structure.

6. The block copolymer according to claim 5, wherein the polyvinyl ether structure is represented by the following general formula (1):
General formula (1) 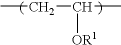
wherein R¹ is selected from the group consisting of a straight chain, branched or cyclic alkyl group having 1 to 18 carbon atoms, —(CH(R²)—CH(R³)—O)₁—R⁴ and —(CH₂)ₘ—(O)ₙ—R⁴; 1 and m are independently selected from integers of 1 to 12, and n is 0 or 1; R² and R³ are independently a hydrogen atom or CH₃; R⁴ is selected from the group consisting of a hydrogen atom, a straight chain, branched or cyclic alkyl group having 1 to 6 carbon atoms, -Ph, -Pyr, -Ph-Ph, -Ph-Pyr, —CHO, —CH₂CHO, —CO—CH═CH₂, —CO—C(CH₃)═CH₂, —CH₂COOR⁵, and -PhCOOR⁵, and when R⁴ is a group other than a hydrogen atom, a hydrogen atom on a carbon atom of the group may be substituted by a straight chain or branched alkyl group having 1 to 4 carbon atoms, and a carbon atom in an aromatic ring of the group may be substituted by a nitrogen atom; R⁵ is a hydrogen atom or an alkyl group having 1 to 5 carbon atoms; and -Ph represents a phenyl group, -Pyr represents a pyrimidyl group, -Ph-Ph represents a biphenyl group, and -Ph-Pyr represents a pyrimidylphenyl group.

7. The block copolymer according to claim 1, wherein the molecular weight distribution of the block copolymer is 1.8 or less.

8. The block copolymer according to claim 1, wherein a glass transition temperature of the block copolymer is 20° C. or less.

9. A polymer-containing composition comprising the block copolymer according to claim 1, a solvent or a dispersion medium, and a functional substance.

10. The polymer containing composition according to claim 9, wherein the functional substance is enfolded with the block copolymer.

11. An ink composition comprising the block copolymer according to claim 1, a solvent or a dispersion medium, and a coloring material.

12. An ink-applying method comprising a step of applying the ink composition according to claim 11 to a medium.

13. An ink-applying apparatus comprising an ink-applying means for energizing the ink composition according to claim 11 to apply the ink composition onto a medium, and a drive means for driving the ink-applying means.
